(19) United States
(12) Patent Application Publication
(10) Pub. No.: US 2022/0214587 A1
(43) Pub. Date: Jul. 7, 2022

(54) DISPLAY PANEL AND METHOD FOR MANUFACTURING THE SAME, DISPLAY MODULE AND DISPLAY DEVICE

(71) Applicants: Beijing BOE Display Technology Co., Ltd., Beijing (CN); BOE Technology Group Co., Ltd., Beijing (CN)

(72) Inventor: Weili ZHAO, Beijing (CN)

(21) Appl. No.: 17/519,333

(22) Filed: Nov. 4, 2021

(30) Foreign Application Priority Data
Jan. 6, 2021 (CN) 202110011947.2

(51) Int. Cl. G02F 1/1362; G02F 1/1368

(52) U.S. Cl. CPC G02F 1/136286; G02F 1/1368

(57) ABSTRACT

The present application provides a display panel, a method for manufacturing the same, a display module and a display device. The display panel includes: an array substrate; a counter substrate arranged oppositely to the array substrate; and a liquid crystal layer between the array substrate and the counter substrate. The array substrate includes a first substrate and a grating structure between the first substrate and the liquid crystal layer. The counter substrate includes a second substrate and a light-scattering structure stacked on the second substrate; and an orthographic projection of the light-scattering structure onto the first substrate at least partially overlaps with an orthographic projection of the grating structure onto the first substrate.

### CROSS-REFERENCE TO RELATED APPLICATIONS

The present application claims a priority to the Chinese patent application No. 202110011947.2 filed in China on Jan. 6, 2021, a disclosure of which is incorporated herein by reference in its entirety.

### TECHNICAL FIELD

The present application relates to the field of display technologies, and in particular to a display panel, a method for manufacturing the same, a display module and a display device.

### BACKGROUND

With continuous development of display technologies, liquid crystal display (LCD) devices have been widely used in various fields. In order to better serve human eyes and restore the real world, LCD technologies continues to develop in directions of high resolution, high contrast, high color gamut and large size. However, the LCD technologies in the related art have problems of crosstalk between adjacent gray scales of different sub-pixels when viewing at a large viewing angle.

### SUMMARY

In a first aspect, one embodiment of the present disclosure provides a display panel, including: an array substrate; a counter substrate arranged oppositely to the array substrate; and a liquid crystal layer between the array substrate and the counter substrate. The array substrate includes a first substrate and a grating structure between the first substrate and the liquid crystal layer. The counter substrate includes a second substrate and a light-scattering structure stacked on the second substrate; and an orthographic projection of the light-scattering structure onto the first substrate at least partially overlaps with an orthographic projection of the grating structure onto the first substrate.

Optionally, the light-scattering structure includes: a quantum dot layer between the second substrate and the liquid crystal layer; and a wire grating structure between the quantum dot layer and the liquid crystal layer.

Optionally, the counter substrate further includes a color resist layer; and the color resist layer is between the second substrate and the quantum dot layer.

Optionally, the color resist layer includes multiple color resist units; the quantum dot layer includes multiple quantum dot patterns; the multiple quantum dot patterns are corresponding to the multiple color resist units in a one-to-one manner; one quantum dot pattern is between the corresponding color resist unit and the liquid crystal layer, and light rays excited by the one quantum dot pattern have the same color as a color of the corresponding color resist unit.

Optionally, the wire grating structure includes multiple wire grating patterns arranged at intervals; an extension direction of the wire grating pattern is perpendicular to a light transmission axis of the grating structure; and the wire grating structure is reused as a second polarizer.

Optionally, the counter substrate includes: a color resist layer between the second substrate and the liquid crystal layer; and a second polarizer at one side of the second substrate that faces away from the liquid crystal layer; wherein the light-scattering structure includes a scattering film; and the scattering film is at one side of the second polarizer facing away from the liquid crystal layer.

Optionally, the grating structure is reused as a first polarizer.

Optionally, the array substrate further includes: a planarization layer at one side of the grating structure facing away from the first substrate; and a driving structure at one side of the planarization layer facing away from the first substrate. The driving structure is configured to generate a driving electric field which drives liquid crystal molecules in the liquid crystal layer to be deflected.

Optionally, the driving structure includes: multiple gate lines, multiple data lines, multiple pixel electrodes, and multiple switching elements. The gate lines and the data lines are arranged to cross each other to define multiple pixel regions. The multiple pixel electrodes are corresponding to at least part of the pixel regions in a one-to-one manner; and the at least part of the pixel regions are in the corresponding pixel regions. The switching element is coupled to the corresponding gate line, the corresponding data line, and the corresponding pixel electrode, respectively; and the switching element is configured to, under control of the corresponding gate line, control turning on or off an electrical connection between the corresponding data line and the corresponding pixel electrode.

In a second aspect, one embodiment of the present disclosure provides a display module, including: a display panel; and a backlight source. The display panel includes: an array substrate; a counter substrate arranged oppositely to the array substrate; and a liquid crystal layer between the array substrate and the counter substrate. The array substrate includes a first substrate and a grating structure between the first substrate and the liquid crystal layer. The counter substrate includes a second substrate and a light-scattering structure stacked on the second substrate; and an orthographic projection of the light-scattering structure onto the first substrate at least partially overlaps with an orthographic projection of the grating structure onto the first substrate. The first substrate includes a light guide substrate. The backlight source is at a lateral side of the light guide substrate, and the backlight source is configured to emit light rays into the light guide substrate.

Optionally, the light-scattering structure includes: a quantum dot layer between the second substrate and the liquid crystal layer; and a wire grating structure between the quantum dot layer and the liquid crystal layer. The backlight source includes a color backlight source.

Optionally, the grating structure is reused as a first polarizer; and the wire grating structure is reused as a second polarizer.

Optionally, the wire grating structure includes multiple wire grating patterns arranged at intervals; and an extension direction of the wire grating pattern is perpendicular to a light transmission axis of the grating structure.

Optionally, the counter substrate further includes a color resist layer; and the color resist layer is between the second substrate and the quantum dot layer.

Optionally, the color resist layer includes multiple color resist units; the quantum dot layer includes multiple quantum dot patterns; the multiple quantum dot patterns are corresponding to the multiple color resist units in a one-to-one manner; one quantum dot pattern is between the corresponding color resist unit and the liquid crystal layer, and light rays excited by the one quantum dot pattern have the same color as a color of the corresponding color resist unit.

Optionally, the counter substrate includes: a color resist layer between the second substrate and the liquid crystal layer; and a second polarizer at one side of the second substrate that faces away from the liquid crystal layer. The light-scattering structure includes a scattering film; and the scattering film is at one side of the second polarizer facing away from the liquid crystal layer. The backlight source includes a white backlight source.

Optionally, the array substrate further includes: a planarization layer at one side of the grating structure facing away from the first substrate; and a driving structure at one side of the planarization layer facing away from the first substrate. The driving structure is configured to generate a driving electric field which drives liquid crystal molecules in the liquid crystal layer to be deflected.

Optionally, the driving structure includes: multiple gate lines, multiple data lines, multiple pixel electrodes, and multiple switching elements; the gate lines and the data lines are arranged to cross each other to define multiple pixel regions; the multiple pixel electrodes are corresponding to at least part of the pixel regions in a one-to-one manner; and the at least part of the pixel regions are in the corresponding pixel regions; the switching element is coupled to the corresponding gate line, the corresponding data line, and the corresponding pixel electrode, respectively; and the switching element is configured to, under control of the corresponding gate line, control turning on or off an electrical connection between the corresponding data line and the corresponding pixel electrode.

In a third aspect, one embodiment of the present disclosure provides a display device, including: a display module which includes a display panel and a backlight source. The display panel includes: an array substrate; a counter substrate arranged oppositely to the array substrate; and a liquid crystal layer between the array substrate and the counter substrate. The array substrate includes a first substrate and a grating structure between the first substrate and the liquid crystal layer. The counter substrate includes a second substrate and a light-scattering structure stacked on the second substrate; and an orthographic projection of the light-scattering structure onto the first substrate at least partially overlaps with an orthographic projection of the grating structure onto the first substrate. The first substrate includes a light guide substrate. The backlight source is at a lateral side of the light guide substrate, and the backlight source is configured to emit light rays into the light guide substrate.

In a fourth aspect, one embodiment of the present disclosure provides a method for manufacturing the display panel in the first aspect. The method includes: fabricating an array substrate; wherein the array substrate includes a first substrate and a grating structure disposed between the first substrate and a liquid crystal layer; and fabricating a counter substrate; wherein the counter substrate includes a second substrate and a light-scattering structure stacked on the second substrate, and an orthographic projection of the light-scattering structure onto the first substrate at least partially overlaps with an orthographic projection of the grating structure onto the first substrate.

Additional aspects and advantages of the present application will be given in the following description, which will become apparent from the following description, or be understood through practice of the present application.

### BRIEF DESCRIPTION OF THE DRAWINGS

The foregoing and/or additional aspects and advantages of the present application will become apparent and easy to understand from the following description of the embodiments in conjunction with the accompanying drawings, in which:

FIG. 1 is a schematic diagram of a first structure of a display module according to an embodiment of the present application;

FIG. 2 is a schematic diagram of a second structure of a display module according to an embodiment of the present application; and

FIG. 3 is a schematic diagram of a third structure of a display module according to an embodiment of the present application.

### DETAILED DESCRIPTION

The present disclosure is described in detail below. Examples of embodiments of the present disclosure are shown in the drawings, where the same or similar reference numerals indicate the same or similar components or components having the same or similar functions. Further, if detailed descriptions of known technologies are unnecessary for the illustrated features of the present disclosure, they are omitted. The embodiments described below with reference to the drawings are exemplary, and only used to explain the present disclosure, and cannot be construed as limiting the present disclosure.

A resolution of an LCD device in the related art depends on sizes of transistors and electrodes in an array substrate as well as a process capability of color resists in a color filter substrate. However, it is still difficult to realize the ultra-fine color resist layer process at present, and thus, in order to make the LCD device have a higher resolution, a pixel island design of sub-pixels subdivided under an identical color resist unit is generally provided within the scope of existing color resist process capabilities, thereby ensuring better viewing angle continuity of 3D display.

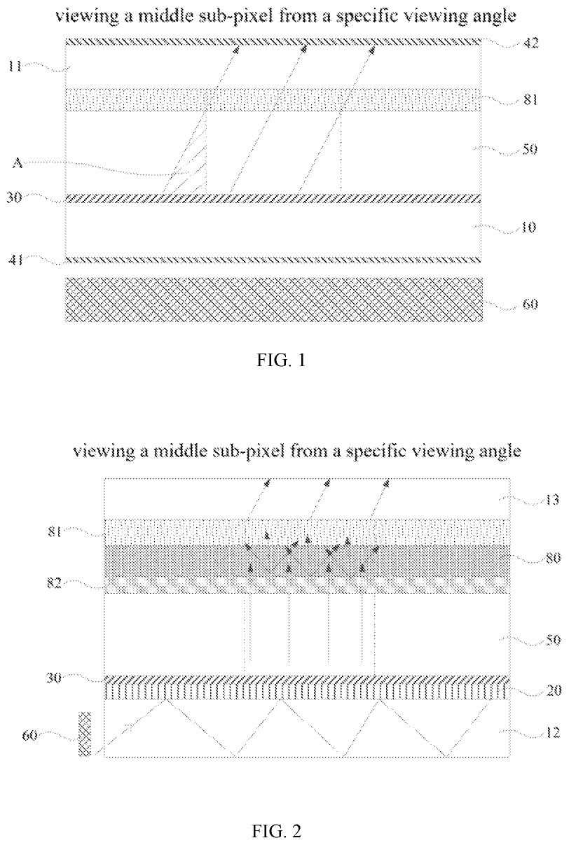

As shown in FIG. 1, a backlight source is a conventional direct-type backlight source. Since the backlight source is a surface light source with various divergence angles, when multiple sub-pixels are subdivided under one color resist unit, light rays emitted at large-angles may pass through liquid crystal molecules of an adjacent sub-pixel and then be emitted into a color resist pattern of a target sub-pixel. The light rays, which pass through the liquid crystal molecules of the adjacent sub-pixel, become a crosstalk signal of a target display area. Therefore, direct subdivision of sub-pixels in the LCD technologies in the related art has problems of crosstalk between adjacent gray scales of different sub-pixels when viewing at a large viewing angle.

It should be noted that, FIG. 1 schematically shows a first substrate 10, a second substrate 11, a first polarizer 41, a second polarizer 42, a driving structure 30, a liquid crystal layer 50, a backlight source 60, and a color resist unit 81. The color resist unit 81 includes three color resist patterns divided by dotted lines. Three sub-pixels are divided by two dotted lines at the liquid crystal layer. The three color resist patterns are corresponding to the three sub-pixels in a one-to-one manner. The foregoing adjacent sub-pixel is a leftmost sub-pixel, and the foregoing target sub-pixel is a middle sub-pixel. A part “A” shown in FIG. 1 is a crosstalk area. Solid lines with arrows in FIG. 1 to FIG. 3 represent transmission of light rays.

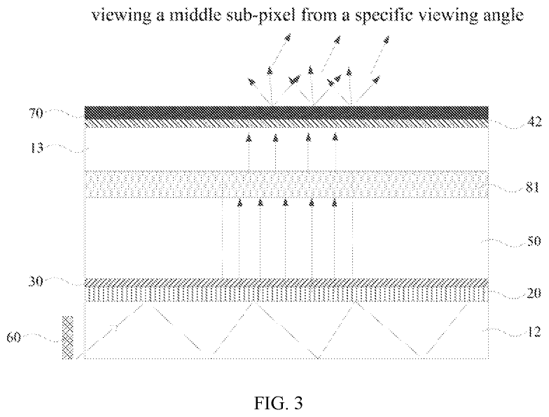

Referring to FIG. 2 and FIG. 3, one embodiment of the present application provides a display panel, including: an array substrate and a counter substrate that are arranged oppositely, and a liquid crystal layer 50 between the array substrate and the counter substrate.

The array substrate includes a first substrate 12 and a grating structure 20 disposed between the first substrate 12 and the liquid crystal layer 50.

The counter substrate includes a second substrate 13 and a light-scattering structure (such as a quantum dot layer 80 and a wire grating structure 82 shown in FIG. 2; or a scattering film 70 shown in FIG. 3) stacked on the second substrate 13. An orthographic projection of the light-scattering structure onto the first substrate 12 at least partially overlaps with an orthographic projection of the grating structure 20 onto the first substrate 12.

In one example, the first substrate 12 and the second substrate 13 each includes a glass optical waveguide structure.

In one example, the grating structure 20 includes multiple grating patterns arranged at intervals along a first direction. The grating patterns are arranged along a second direction. The first direction intersects the second direction.

In one example, the light-scattering structure is located between the second substrate 13 and the liquid crystal layer 50; or the light-scattering structure is located at one side of the second substrate 13 that faces away from the liquid crystal layer 50.

In one example, the orthographic projection of the grating structure 20 onto the first substrate 12 is located within the orthographic projection of the light-scattering structure onto the first substrate 12.

In one example, a backlight source 60 is provided at one side of the array substrate facing away from the liquid crystal layer 50. Light rays emitted from the backlight source 60 enter the grating structure 20 through the first substrate 12, then exit from the grating structure 20 as collimated light rays, and then enter the liquid crystal layer 50. Then, the collimated light rays are emitted from the liquid crystal layer 50 to the counter substrate, scattered at the light-scattering structure in the counter substrate, and then scattered light rays enter the human eyes.

According to the specific structure of the foregoing display panel, in the display panel provided in the embodiment of the present application, the presence of the grating structure 20 in the array substrate turns the light rays into collimated light rays which enter the liquid crystal layer 50, thereby ensuring that the light rays entering the liquid crystal layer 50 will not pass through liquid crystal molecules of an adjacent sub-pixel to enter into liquid crystal molecules of a target sub-pixel, and then preventing light rays carrying wrong gray-scale information of the adjacent sub-pixel from entering the liquid crystal molecules of the target sub-pixel, which solves the problems of crosstalk between adjacent gray scales of different sub-pixels when viewing at a large viewing angle, existed in the direct subdivision of sub-pixels in the LCD technologies in the related art. Further, the presence of the light-scattering structure in the counter substrate enables light rays to be emitted to a viewer at various angles, thereby ensuring visibility of the display panel at various viewing angles.

As shown in FIG. 2, in some embodiments, the light-scattering structure includes a quantum dot layer 80. The quantum dot layer 80 is located between the second substrate 13 and the liquid crystal layer 50. The light-scattering structure further includes a wire grating structure 82. The wire grating structure 82 is located between the quantum dot layer 80 and the liquid crystal layer 50.

In one example, the wire grating structure 82 includes a metal wire grating structure.

In one example, the quantum dot layer 80 includes quantum dot patterns of multiple colors. When light rays enter the quantum dot patterns of different colors, secondary excitation of the light rays in the quantum dot patterns of different colors produces light rays of different colors.

In the display panel provided in the foregoing embodiment, due to a light depolarization effect of the quantum dot layer 80, by the presence of the wire grating structure 82 under the quantum dot layer 80, pixel gray-scale information can be extracted in advance, thereby preventing gray-scales from being unable to be modulated by an upper polarizer after depolarization. Furthermore, the quantum dot layer 80 can disperse the collimated light rays, thereby ensuring that the human eyes can see the light rays emitted by the sub-pixels in all viewing angles.

As shown in FIG. 2, in some embodiments, the counter substrate further includes a color resist layer. The color resist layer is located between the second substrate 13 and the quantum dot layer 80.

In the display panel provided in the foregoing embodiment, the presence of the color resist layer between the second substrate 13 and the quantum dot layer 80 can passivate light rays emitted by the quantum dot layer 80, thereby better improving the viewer's visual experience.

As shown in FIG. 2, in some embodiments, the color resist layer includes multiple color resist units 81. The quantum dot layer 80 includes multiple quantum dot patterns. The multiple quantum dot patterns are corresponding to the multiple color resist units 81 in a one-to-one manner. One quantum dot pattern is located between the corresponding color resist unit 81 and the liquid crystal layer 50, and light rays excited by the one quantum dot pattern have the same color as a color of the corresponding color resist unit 81.

In one example, the color resist layer includes multiple color resist units 81. The multiple color resist units 81 include color resist units 81 of multiple colors. In one example, the multiple color resist units 81 include multiple red color resist units, multiple green color resist units and multiple blue color resist units. It should be noted that FIG. 2 and FIG. 3 schematically show that the color resist unit 81 includes three color resist patterns of the same color.

In one example, each color resist unit 81 includes multiple color resist patterns of the same color, and the multiple color resist patterns of the same color are formed into an integrated structure. In one identical color resist unit 81, there is no black matrix between adjacent color resist patterns. In one example, there is a black matrix between adjacent color resist units 81.

In one example, the quantum dot layer 80 includes multiple quantum dot patterns, and the multiple quantum dot patterns include quantum dot patterns of multiple colors. For example, the multiple quantum dot patterns include multiple red quantum dot patterns, multiple green quantum dot patterns and multiple blue quantum dot patterns.

In one example, the multiple quantum dot patterns are corresponding to the multiple color resist units 81 in a one-to-one manner. One quantum dot pattern and its corresponding color resist unit 81 have the same color, and light rays excited by the one quantum dot pattern have the same color as a color of the corresponding color resist unit 81.

In one example, a blue polarized light source is provided at one side of the array substrate facing away from the liquid crystal layer 50. Blue light rays emitted by the blue polarized light source are incident into the green quantum dot pattern through the wire grating structure 82, thereby exciting green light rays in the green quantum dot pattern. Blue light rays emitted by the blue polarized light source are incident into the red quantum dot pattern through the wire grating structure 82, thereby exciting red light rays in the red quantum dot pattern.

As shown in FIG. 2, in some embodiments, the wire grating structure 82 includes multiple wire grating patterns arranged at intervals. An extension direction of the wire grating pattern is perpendicular to a light transmission axis of the grating structure 20. The wire grating structure 82 is reused as a second polarizer.

In one example, the wire grating structure 82 includes multiple wire grating patterns arranged at equal intervals.

In one example, the extension direction of the wire grating pattern is perpendicular to an extension direction of the light transmission axis of the grating structure 20.

In one example, the grating structure 20 is reused as a first polarizer, and the wire grating structure 82 is reused as a second polarizer.

In the display panel provided in the foregoing embodiment, the wire grating structure 82 is reused as the second polarizer, there avoiding a separate second polarizer 42 in the display panel shown in FIG. 1, which is not only conducive to the thinner development of the display panel, but also reduces manufacturing cost of the display panel.

As shown in FIG. 3, in some embodiments, the counter substrate includes:

a color resist layer located between the second substrate 13 and the liquid crystal layer 50; and

a second polarizer 42 located at one side of the second substrate 13 that faces away from the liquid crystal layer 50.

The light-scattering structure includes a scattering film 70. The scattering film 70 is located at one side of the second polarizer 42 facing away from the liquid crystal layer 50.

In one example, the color resist layer includes multiple color resist units 81. The multiple color resist units 81 include color resist units 81 of multiple colors. For example, the multiple color resist units 81 include multiple red color resist units 81, multiple green color resist units 81 and multiple blue color resist units 81.

In one example, each color resist unit 81 includes multiple color resist patterns of the same color, and the multiple color resist patterns of the same color are formed into an integrated structure. In one identical color resist unit 81, there is no black matrix between adjacent color resist patterns. In one example, there is a black matrix between adjacent color resist units 81.

In one example, an extension direction of a light transmission axis of the second polarizer is perpendicular to an extension direction of the light transmission axis of the grating structure 20.

In one example, the second polarizer may be prepared in advance, and may be directly attached to a surface of the second substrate 13 facing away from the liquid crystal layer 50.

The presence of the scattering film 70 on one side of the second polarizer facing away from the liquid crystal layer 50 can better ensure large viewing angle visibility of the display pane.

In one example, a white polarized light source is provided at one side of the array substrate facing away from the liquid crystal layer 50. White light rays emitted by the white polarized light source are transmitted to the grating structure 20 through the first substrate with an optical waveguide function, and then emitted from the grating structure 20 as white collimated light rays. Then, the white collimated light rays emitted from the grating structure 20 enter the liquid crystal layer 50. Since the collimated light rays are white collimated light rays, the quantum dot layer 80 can be omitted, so that the white collimated light rays directly enter the color resist layer and pass through the color resist layer, and then sequentially pass through the second substrate 13, the second polarizer 42 and the scattering film 70 and then enter the human eyes without carrying any crosstalk information.

As shown in FIG. 2 and FIG. 3, in some embodiments, the grating structure 20 is reused as a first polarizer.

In the display panel provided in the foregoing embodiment, the grating structure 20 is reused as the first polarizer, thereby avoiding a separate first polarizer 41 in the display panel shown in FIG. 1, which is not only conducive to the thinner development of the display panel, but also reduces manufacturing cost of the display panel.

As shown in FIG. 2 and FIG. 3, in some embodiments, the array substrate further includes:

a planarization layer located at one side of the grating structure 20 facing away from the first substrate 12; and

a driving structure 30 located at one side of the planarization layer facing away from the first substrate 12.

The driving structure 30 is configured to generate a driving electric field which drives the liquid crystal molecules in the liquid crystal layer 50 to be deflected.

In one example, the planarization layer is made of organic materials.

In one example, the driving structure 30 is located at a surface of the planarization layer facing away from the first substrate 12.

In the display panel provided in the foregoing embodiment, the presence of the driving structure 30 at the side of the planarization layer facing away from the first substrate 12 can better ensure that the driving structure 30 can be formed on a flat surface, which helps to improve display quality of the display panel.

In some embodiments, the driving structure 30 includes: multiple gate lines, multiple data lines, multiple pixel electrodes, and multiple switching elements.

The gate lines and the data lines are arranged to cross each other to define multiple pixel regions.

The multiple pixel electrodes are corresponding to at least part of the pixel regions in a one-to-one manner. The at least part of the pixel regions are located in the corresponding pixel regions.

The switching element is coupled to the corresponding gate line, the corresponding data line, and the corresponding pixel electrode, respectively. The switching element is configured to, under control of the corresponding gate line, control turning on or off an electrical connection between the corresponding data line and the corresponding pixel electrode.

In one example, an orthographic projection of the gate line onto the first substrate 12 intersects an orthographic projection of the data line onto the first substrate 12 to define multiple pixel regions.

In one example, the multiple pixel electrodes are corresponding to at least part of the pixel regions in a one-to-one manner. An orthographic projection of the pixel electrode onto the first substrate 12 at least partially overlaps an orthographic projection of the corresponding pixel region onto the first substrate 12.

In one example, the switching element includes a transistor. A gate electrode of the transistor is coupled to the corresponding gate line. A first electrode of the transistor is coupled to the corresponding data line. A second electrode of the transistor is coupled to the corresponding pixel electrode. The transistor is configured to, under control of the corresponding gate line, control turning on or off an electrical connection between the corresponding data line and the corresponding pixel electrode.

In one example, the display panel further includes a common electrode. The common electrode is located on the array substrate or on the counter substrate. A driving electric field is generated between the common electrode and the pixel electrode to drive the liquid crystal molecules in the liquid crystal layer 50 to be deflected.

In one example, an alignment layer is provided at one side of the array substrate facing the liquid crystal layer 50, and an alignment layer is provided at one side of the counter substrate facing the liquid crystal layer 50. Spacers with supporting effect are arranged between the array substrate and the counter substrate. A sealant is arranged in a packaging area between the array substrate and the counter substrate.

As shown in FIG. 2 and FIG. 3, one embodiment of the present application further provides a display module which includes the display panel provided in the foregoing embodiment. The first substrate 12 of the display panel includes a light guide substrate. The display module further includes a backlight source 60 located at a lateral side of the light guide substrate. Light rays emitted by the backlight source 60 can enter the light guide substrate.

In one example, the backlight source 60 is located at the lateral side of the light guide substrate, thereby forming a side-type backlight.

In one example, the first substrate 12 includes a glass light guide substrate.

In the display module provided in the embodiment of the present application, the presence of the grating structure 20 in the array substrate turns the light rays into collimated light rays which enter the liquid crystal layer 50, thereby ensuring that the light rays entering the liquid crystal layer 50 will not pass through liquid crystal molecules of an adjacent sub-pixel to enter into liquid crystal molecules of a target sub-pixel, and then preventing light rays carrying wrong gray-scale information of the adjacent sub-pixel from entering the liquid crystal molecules of the target sub-pixel, which solves the problems of crosstalk between adjacent gray scales of different sub-pixels when viewing at a large viewing angle, existed in the direct subdivision of sub-pixels in the LCD technologies in the related art. Further, the presence of the light-scattering structure in the counter substrate enables light rays to be emitted to a viewer at various angles, thereby ensuring visibility of the display panel at various viewing angles.

As shown in FIG. 2, in some embodiments, the light-scattering structure in the display panel includes a quantum dot layer 80. The quantum dot layer 80 is located between the second substrate 13 and the liquid crystal layer 50. The light-scattering structure further includes a wire grating structure 82. The wire grating structure 82 is located between the quantum dot layer 80 and the liquid crystal layer 50. The backlight source 60 includes a color backlight source 60.

In one example, the wire grating structure 82 includes a metal wire grating structure.

In one example, the quantum dot layer 80 includes quantum dot patterns of multiple colors. When light rays enter the quantum dot patterns of different colors, secondary excitation of the light rays in the quantum dot patterns of different colors produces light rays of different colors.

In one example, the color backlight source 60 includes a blue polarized light source.

In one example, the blue polarized light source is provided at one side of the array substrate facing away from the liquid crystal layer 50. Blue light rays emitted by the blue polarized light source can be coupled into the first substrate 12 and emitted into the wire grating structure 82 through the first substrate 12, and then emitted from the wire grating structure 82 as blue collimated light rays. The blue collimated light rays pass through the liquid crystal layer 50 and enter into the corresponding quantum dot pattern to excite light rays of a color corresponding to the quantum dot pattern.

In the display module provided in the foregoing embodiment, due to a light depolarization effect of the quantum dot layer 80, by the presence of the wire grating structure 82 under the quantum dot layer 80, pixel gray-scale information can be extracted in advance, thereby preventing gray-scales from being unable to be modulated by an upper polarizer after depolarization. Furthermore, the quantum dot layer 80 can disperse the collimated light rays, thereby ensuring that the human eyes can see the light rays emitted by the sub-pixels in all viewing angles.

As shown in FIG. 3, in some embodiments, the counter substrate of the display panel includes:

a color resist layer located between the second substrate 13 and the liquid crystal layer 50; and

a second polarizer 42 located at one side of the second substrate 13 that faces away from the liquid crystal layer 50.

The light-scattering structure includes a scattering film 70. The scattering film 70 is located at one side of the second polarizer 42 facing away from the liquid crystal layer 50.

In one example, the backlight source 60 includes a white backlight source 60.

In one example, the color resist layer includes multiple color resist units 81. The multiple color resist units 81 include color resist units 81 of multiple colors. For example, the multiple color resist units 81 include multiple red color resist units 81, multiple green color resist units 81 and multiple blue color resist units 81.

In one example, each color resist unit 81 includes multiple color resist patterns of the same color, and the multiple color resist patterns of the same color are formed into an integrated structure. In one identical color resist unit 81, there is no black matrix between adjacent color resist patterns. In one example, there is a black matrix between adjacent color resist units 81.

In one example, an extension direction of a light transmission axis of the second polarizer is perpendicular to an extension direction of a light transmission axis of the grating structure 20.

In one example, the second polarizer may be prepared in advance, and may be directly attached to a surface of the second substrate 13 facing away from the liquid crystal layer 50.

The presence of the scattering film 70 on one side of the second polarizer facing away from the liquid crystal layer 50 can better ensure large viewing angle visibility of the display pane.

In one example, a white polarized light source is provided at one side of the array substrate facing away from the liquid crystal layer 50. White light rays emitted by the white polarized light source are transmitted to the grating structure 20 through the first substrate with an optical waveguide function, and then emitted from the grating structure 20 as white collimated light rays. Then, the white collimated light rays emitted from the grating structure 20 enter the liquid crystal layer 50. Since the collimated light rays are white collimated light rays, the quantum dot layer 80 can be omitted, so that the white collimated light rays directly enter the color resist layer and pass through the color resist layer, and then sequentially pass through the second substrate 13, the second polarizer 42 and the scattering film 70 and then enter the human eyes without carrying any crosstalk information.

One embodiment of the present application further provides a display device, including the display module provided in the foregoing embodiment.

In the display module provided in the foregoing embodiment, the presence of the grating structure 20 in the array substrate turns the light rays into collimated light rays which enter the liquid crystal layer 50, thereby ensuring that the light rays entering the liquid crystal layer 50 will not pass through liquid crystal molecules of an adjacent sub-pixel to enter into liquid crystal molecules of a target sub-pixel, and then preventing light rays carrying wrong gray-scale information of the adjacent sub-pixel from entering the liquid crystal molecules of the target sub-pixel, which solves the problems of crosstalk between adjacent gray scales of different sub-pixels when viewing at a large viewing angle, existed in the direct subdivision of sub-pixels in the LCD technologies in the related art. Further, the presence of the light-scattering structure in the counter substrate enables light rays to be emitted to a viewer at various angles, thereby ensuring visibility of the display panel at various viewing angles.

Since the display device provided in the embodiment of the present application includes the foregoing display module, the display device also has the foregoing beneficial effects.

It should be noted that the display device may be any product or component with a display function, such as a TV, a monitor, a digital photo frame, a mobile phone, a tablet computer.

One embodiment of the present application further provides a display panel manufacturing method for manufacturing the display panel provided in the foregoing embodiment. The display panel includes: an array substrate and a counter substrate that are arranged oppositely, and a liquid crystal layer 50 between the array substrate and the counter substrate. The method includes:

fabricating an array substrate; where the array substrate includes a first substrate 12 and a grating structure 20 disposed between the first substrate 12 and the liquid crystal layer 50; and

fabricating a counter substrate; where the counter substrate includes a second substrate 13 and a light-scattering structure stacked on the second substrate 13, and an orthographic projection of the light-scattering structure onto the first substrate 12 at least partially overlaps with an orthographic projection of the grating structure 20 onto the first substrate 12.

In the display panel manufactured by the method provided in the embodiment of the present application, the presence of the grating structure 20 in the array substrate turns the light rays into collimated light rays which enter the liquid crystal layer 50, thereby ensuring that the light rays entering the liquid crystal layer 50 will not pass through liquid crystal molecules of an adjacent sub-pixel to enter into liquid crystal molecules of a target sub-pixel, and then preventing light rays carrying wrong gray-scale information of the adjacent sub-pixel from entering the liquid crystal molecules of the target sub-pixel, which solves the problems of crosstalk between adjacent gray scales of different sub-pixels when viewing at a large viewing angle, existed in the direct subdivision of sub-pixels in the LCD technologies in the related art. Further, the presence of the light-scattering structure in the counter substrate enables light rays to be emitted to a viewer at various angles, thereby ensuring visibility of the display panel at various viewing angles.

It should be noted that the various embodiments in this specification are described in a progressive manner, and the same or similar parts between the various embodiments can be referred to each other, and each embodiment focuses on differences from other embodiments. In particular, for the method embodiment, since it is basically similar to the product embodiment, the description is relatively simple, and the relevant part can refer to the part of the description of the product embodiment.

Those skilled in the art can understand that steps, measures, or solutions in various operations, methods or processes that have been discussed in the present disclosure may be alternated, changed, combined, or deleted. Further, other steps, measures, or solutions in various operations, methods or processes that have been discussed in the present disclosure can be alternated, modified, rearranged, decomposed, combined, or deleted. Further, steps, measures, or solutions in various operations, methods or processes in the conventional technologies can be alternated, modified, rearranged, decomposed, combined, or deleted.

In the descriptions of the present disclosure, it needs to be understood that orientation or positional relationship indicated by the term of “center”, “up”, “down”, “front”, “rear”, “left”, “right”, “vertical”, “horizontal”, “top”, “bottom”, “inside”, or “outer”, etc., is based on the drawings, and are only for the convenience of describing the present disclosure and simplifying the description, and not intended to indicate or imply that the device or element as referred to must have a specific orientation or be constructed and operated in a specific orientation, and therefore cannot be understood as a limitation to the present disclosure.

The terms “first” and “second” are used for descriptive purposes only, and cannot be understood as indicating or implying relative importance or implicitly indicating the quantity of technical features as referred to. Therefore, the features defined by “first” and “second” may explicitly or implicitly include one or more of the features. In the descriptions of the present disclosure, unless otherwise stated, “a plurality” means two or more.

In the description of the present disclosure, it should be noted that the term of “installation”, “connected”, or “connecting” should be understood in a broad sense unless explicitly stated and limited. For example, it may be fixed or removable connection, or may be integral connection; it may be direct connection or indirect connection through an intermediate medium, or, it may be internal communication of two elements. For those of ordinary skill in the art, the specific meanings of the above terms in the present disclosure may be understood on a case-by-case basis.

In the descriptions of this specification, specific features, structures, materials, or characteristics may be combined in a suitable manner in any one or more embodiments or examples.

The above descriptions are merely some embodiments of the present disclosure. It should be noted that for those of ordinary skill in the art, without departing from the principles of the present disclosure, various improvements and modifications can be made. These improvements and modifications should fall within the protection scope of the present disclosure.

What is claimed is:

1. A display panel, comprising:
an array substrate;
a counter substrate arranged oppositely to the array substrate; and
a liquid crystal layer between the array substrate and the counter substrate;
wherein the array substrate includes a first substrate and a grating structure between the first substrate and the liquid crystal layer;
the counter substrate includes a second substrate and a light-scattering structure stacked on the second substrate; and an orthographic projection of the light-scattering structure onto the first substrate at least partially overlaps with an orthographic projection of the grating structure onto the first substrate.

2. The display panel of claim 1, wherein the light-scattering structure includes:
a quantum dot layer between the second substrate and the liquid crystal layer; and
a wire grating structure between the quantum dot layer and the liquid crystal layer.

3. The display panel of claim 2, wherein the counter substrate further includes a color resist layer; and the color resist layer is between the second substrate and the quantum dot layer.

4. The display panel of claim 3, wherein the color resist layer includes multiple color resist units;
the quantum dot layer includes multiple quantum dot patterns;
the multiple quantum dot patterns are corresponding to the multiple color resist units in a one-to-one manner; one quantum dot pattern is between the corresponding color resist unit and the liquid crystal layer, and light rays excited by the one quantum dot pattern have the same color as a color of the corresponding color resist unit.

5. The display panel of claim 2, wherein the wire grating structure includes multiple wire grating patterns arranged at intervals; an extension direction of the wire grating pattern is perpendicular to a light transmission axis of the grating structure;
and the wire grating structure is reused as a second polarizer.

6. The display panel of claim 1, wherein the counter substrate includes:
a color resist layer between the second substrate and the liquid crystal layer; and
a second polarizer at one side of the second substrate that faces away from the liquid crystal layer;
wherein the light-scattering structure includes a scattering film; and the scattering film is at one side of the second polarizer facing away from the liquid crystal layer.

7. The display panel of claim 1, wherein the grating structure is reused as a first polarizer.

8. The display panel of claim 1, wherein the array substrate further includes:
a planarization layer at one side of the grating structure facing away from the first substrate; and
a driving structure at one side of the planarization layer facing away from the first substrate;
wherein the driving structure is configured to generate a driving electric field which drives liquid crystal molecules in the liquid crystal layer to be deflected.

9. The display panel of claim 8, wherein the driving structure includes:
multiple gate lines, multiple data lines, multiple pixel electrodes, and multiple switching elements;
the gate lines and the data lines are arranged to cross each other to define multiple pixel regions;
the multiple pixel electrodes are corresponding to at least part of the pixel regions in a one-to-one manner; and the at least part of the pixel regions are in the corresponding pixel regions;
the switching element is coupled to the corresponding gate line, the corresponding data line, and the corresponding pixel electrode, respectively; and the switching element is configured to, under control of the corresponding gate line, control turning on or off an electrical connection between the corresponding data line and the corresponding pixel electrode.

10. A display module, comprising:
a display panel; and
a backlight source;
wherein the display panel includes:
an array substrate;
a counter substrate arranged oppositely to the array substrate; and
a liquid crystal layer between the array substrate and the counter substrate;
wherein the array substrate includes a first substrate and a grating structure between the first substrate and the liquid crystal layer;
the counter substrate includes a second substrate and a light-scattering structure stacked on the second substrate; and an orthographic projection of the light-scattering structure onto the first substrate at least partially overlaps with an orthographic projection of the grating structure onto the first substrate;
the first substrate includes a light guide substrate;
the backlight source is at a lateral side of the light guide substrate, and the backlight source is configured to emit light rays into the light guide substrate.

11. The display module of claim 10, wherein the light-scattering structure includes:
a quantum dot layer between the second substrate and the liquid crystal layer; and
a wire grating structure between the quantum dot layer and the liquid crystal layer;
wherein the backlight source includes a color backlight source.

12. The display module of claim 11, wherein the grating structure is reused as a first polarizer; and the wire grating structure is reused as a second polarizer.

13. The display module of claim 12, wherein the wire grating structure includes multiple wire grating patterns arranged at intervals; and an extension direction of the wire grating pattern is perpendicular to a light transmission axis of the grating structure.

14. The display module of claim 11, wherein the counter substrate further includes a color resist layer; and the color resist layer is between the second substrate and the quantum dot layer.

15. The display module of claim 14, wherein the color resist layer includes multiple color resist units;
the quantum dot layer includes multiple quantum dot patterns;
the multiple quantum dot patterns are corresponding to the multiple color resist units in a one-to-one manner; one quantum dot pattern is between the corresponding color resist unit and the liquid crystal layer, and light rays excited by the one quantum dot pattern have the same color as a color of the corresponding color resist unit.

16. The display module of claim 10, wherein the counter substrate includes:
a color resist layer between the second substrate and the liquid crystal layer; and
a second polarizer at one side of the second substrate that faces away from the liquid crystal layer;
wherein the light-scattering structure includes a scattering film; and the scattering film is at one side of the second polarizer facing away from the liquid crystal layer;
wherein the backlight source includes a white backlight source.

17. The display module of claim 10, wherein the array substrate further includes:
a planarization layer at one side of the grating structure facing away from the first substrate; and
a driving structure at one side of the planarization layer facing away from the first substrate;
wherein the driving structure is configured to generate a driving electric field which drives liquid crystal molecules in the liquid crystal layer to be deflected.

18. The display module of claim 17, wherein the driving structure includes:
multiple gate lines, multiple data lines, multiple pixel electrodes, and multiple switching elements;
the gate lines and the data lines are arranged to cross each other to define multiple pixel regions;
the multiple pixel electrodes are corresponding to at least part of the pixel regions in a one-to-one manner; and the at least part of the pixel regions are in the corresponding pixel regions;
the switching element is coupled to the corresponding gate line, the corresponding data line, and the corresponding pixel electrode, respectively; and the switching element is configured to, under control of the corresponding gate line, control turning on or off an electrical connection between the corresponding data line and the corresponding pixel electrode.

19. A display device, comprising:
a display module including:
a display panel; and
a backlight source;
wherein the display panel includes:
an array substrate;
a counter substrate arranged oppositely to the array substrate; and
a liquid crystal layer between the array substrate and the counter substrate;
wherein the array substrate includes a first substrate and a grating structure between the first substrate and the liquid crystal layer;
the counter substrate includes a second substrate and a light-scattering structure stacked on the second substrate; and an orthographic projection of the light-scattering structure onto the first substrate at least partially overlaps with an orthographic projection of the grating structure onto the first substrate;
the first substrate includes a light guide substrate;
the backlight source is at a lateral side of the light guide substrate, and the backlight source is configured to emit light rays into the light guide substrate.

20. A method for manufacturing the display panel of claim 1, comprising:
fabricating an array substrate; wherein the array substrate includes a first substrate and a grating structure disposed between the first substrate and a liquid crystal layer; and
fabricating a counter substrate; wherein the counter substrate includes a second substrate and a light-scattering structure stacked on the second substrate, and an orthographic projection of the light-scattering structure onto the first substrate at least partially overlaps with an orthographic projection of the grating structure onto the first substrate.
